(19) United States
(12) Patent Application Publication
(10) Pub. No.: US 2009/0026020 A1
(43) Pub. Date: Jan. 29, 2009

(54) ELEVATING DEVICE AND CONTROL METHOD THEREOF, AND IMAGING APPARATUS

(76) Inventor: Akira Izuhara, Tokyo (JP)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 12/178,476

(22) Filed: Jul. 23, 2008

(30) Foreign Application Priority Data
Jul. 23, 2007 (JP) 2007-190909

(51) Int. Cl. B66B 9/04; B66B 3/00

(52) U.S. Cl. 187/275; 187/391

(57) ABSTRACT

An elevating device based on fluid control includes a pump and a cylinder that are connected to each other by a flow path, wherein the cylinder and a reservoir are connected to each other by a flow path via a fixed flow valve that allows fluid to flow at a predetermined flow rate. When a lowering operation of a table section is carried out, a pump-valve control unit brings a flow rate of discharge of the fluid by the pump and a flow rate of the fluid returned to the reservoir through the fixed flow valve into equilibrium and thereafter sets the flow rate of discharge of the fluid by the pump smaller than the predetermined flow rate thereby to reduce the amount of the fluid held in the cylinder.

### CROSS REFERENCE TO RELATED APPLICATIONS

This application claims the benefit of Japanese Patent Application No. 2007-190909 filed Jul. 23, 2007, which is incorporated by reference in its entirety.

### BACKGROUND OF THE INVENTION

The subject matter disclosed herein relates to an elevating device and its control method and an imaging apparatus, and particularly to an elevating device for implementing an elevating operation by fluid control such as hydraulic control and a control method thereof, and an imaging apparatus using the elevating device.

There has heretofore been known an elevator or elevating device which realizes an elevating operation by controlling the amount of fluid, e.g., oil held in a cylinder of an actuator.

As the elevating device based on such fluid control, there has been known an elevating device which controls the flow rate of fluid discharged from a cylinder using a proportional control valve capable of adjusting the degree of opening thereof, thereby making it possible to suppress impact at its startup and stop under a lowering operation thereof (refer to, for example, Japanese Unexamined Patent Publication No. 2006-158583). Such an impact reduced elevating device is better suitable for, for example, such an application as to place a human body and other object weak in impact thereon and elevate.

### BRIEF DESCRIPTION OF THE INVENTION

In the above elevating device, however, the proportional control valve itself to be used is expensive. In addition to it, time and trouble are taken over adjustments and management or the like for controlling the flow rate of the proportional control valve as intended, and the cost is increased.

With the foregoing in view, the present invention aims to provide an elevating device based on fluid control, which is less reduced in impact at a lowering operation and capable of bringing costs down, and a control method thereof, and an imaging apparatus using such a elevating device.

In a first aspect, the present invention provides a elevating device comprising a reservoir which reserves fluid therein, a pump having a suction port and a discharge port, a cylinder which elevates an object to be elevated according to an amount of fluid held therein, a first flow path which connects the reservoir and the suction port of the pump, a second flow path which connects the discharge port of the pump and the cylinder, a third flow path which connects the cylinder and the reservoir, a fixed flow valve which is provided on the third flow path and causes fluid to flow at a predetermined flow rate, and control device for controlling the pump, to lower the object to be elevated, so as to adjust a flow rate of discharge of the fluid by the pump to the same flow rate as the predetermined flow rate thereby to bring the discharge flow rate and a flow rate of the fluid returned to the reservoir through the fixed flow valve into equilibrium, and thereafter make the discharge flow rate smaller than the predetermined flow rate thereby to reduce the amount of the fluid held in the cylinder.

In a second aspect, the present invention provides the elevating device according to the first aspect, further including a first opening/closing valve provided on the second flow path, a second opening/closing valve provided on the third flow path, and a relief valve provided between the discharge port of the pump and the reservoir through a flow path interposed therebetween, wherein said control device controls the pump, the first opening/closing valve and the second opening/closing valve so as to adjust the discharge flow rate to the same flow rate as the predetermined flow rate in a state in which the first opening/closing valve and the second opening/closing valve are being closed therefore returns the fluid discharged from the pump to the reservoir via the relief valve, and thereafter open the first opening/closing valve and the second opening/closing valve simultaneously therefore to bring the discharge flow rate and the flow rate of the fluid returned to the reservoir into equilibrium.

In a third aspect, the present invention provides the elevating device according to the second aspect, wherein the relief valve is built in a pump unit including the pump and the reservoir.

In a fourth aspect, the present invention provides the elevating device according to the second or third aspect, wherein said control device controls, to stop the lowering object to be elevated, so as to restore the discharge flow rate to the same flow rate as the predetermined flow rate and close the first opening/closing valve and the second opening/closing valve.

In a fifth aspect, the present invention provides the elevating device according to any one of the second to fourth aspects, wherein said control device controls, to lift the object to be elevated, so as to open the first opening/closing valve in a closed state of the second opening/closing valve thereby discharge the fluid from the pump to increase the amount of the fluid held in the cylinder.

In a sixth aspect, the present invention provides the elevating device according to any one of the second to fifth aspects, further including a check valve for making the fluid flow direction to the direction extending from the first opening/closing valve to the cylinder, which is provided on the second flow path between the first opening/closing valve and the cylinder and sets.

In a seventh aspect, the present invention provides the elevating device according to any one of the first to sixth aspects, wherein the object to be elevated is a table section which supports a subject and is moved into an imaging space by a table moving section.

In an eighth aspect, the present invention provides the elevating device according to any one of the first to seventh aspects, wherein said control device controls the object to be elevated, based on at least one input information of a direction, an amount, a position and a velocity of the object to be elevated to be moved.

In a ninth aspect, the present invention provides the elevating device according to any one of the first to eighth aspects, wherein the pump is a gear pump.

In a tenth aspect, the present invention provides the elevating device according to any one of the first to ninth aspects, wherein the fluid is oil.

In an eleventh aspect, the present invention provides a method for controlling a elevating device for elevating an object to be elevated, having a reservoir which reserves fluid therein, a pump having a suction port and a discharge port, a cylinder which elevates an object to be elevated according to an amount of fluid held therein, a first flow path which connects the reservoir and the suction port of the pump, a second flow path which connects the discharge pot of the pump and the cylinder, a third flow path which connects the cylinder and the reservoir, and a fixed flow valve which is provided on the third flow path and causes fluid to flow at a predetermined flow rate, said method comprising a step of controlling the pump, to lower the object to be elevated, so as to adjust a flow rate of discharge of the fluid by the pump to the same flow rate as the predetermined flow rate thereby to bring the discharge flow rate and a flow rate of the fluid returned to the reservoir through the fixed flow valve into equilibrium, and thereafter make the discharge flow rate smaller than the predetermined flow rate thereby to reduce the amount of the fluid held in the cylinder.

In a twelfth aspect, the present invention provides an imaging apparatus comprising a table section which supports a subject, a table moving section which moves the table section to an imaging space, and imaging device which images the subject supported by the table section moved into the imaging space by the table moving section, wherein the table moving section includes a reservoir which reserves fluid therein, a pump having a suction port and a discharge port, a cylinder which elevates an object to be elevated according to an amount of fluid held therein, a first flow path which connects the reservoir and the suction port of the pump, a second flow path which connects the discharge port of the pump and the cylinder, a third flow path which connects the cylinder and the reservoir, a fixed flow valve which is provided on the third flow path and causes fluid to flow at a predetermined flow rate, and control device for controlling the pump, to lower the object to be elevated, so as to adjust a flow rate of discharge of the fluid by the pump to the same flow rate as the predetermined flow rate thereby to bring the discharge flow rate and a flow rate of the fluid returned to the reservoir through the fixed flow valve into equilibrium, and thereafter make the discharge flow rate smaller than the predetermined flow rate thereby to reduce the amount of the fluid held in the cylinder.

In a thirteenth aspect, the present invention provides the imaging apparatus according to the twelfth aspect, wherein the table moving section further include a first opening/closing valve provided on the second flow path, a second opening/closing valve provided on the third flow path, and a relief valve provided between the discharge port of the pump and the reservoir through a flow path interposed therebetween, and wherein said control device controls the pump, the first opening/closing valve and the second opening/closing valve so as to adjust the discharge flow rate to the same flow, rate as the predetermined flow rate in a state in which the first opening/closing valve and the second opening/closing valve are being closed therefore returns the fluid discharged from the pump to the reservoir via the relief valve, and thereafter open the first opening/closing valve and the second opening/closing valve simultaneously therefore to bring the discharge flow rate and the flow rate of the fluid returned to the reservoir into equilibrium.

In a fourteenth aspect, the present invention provides the imaging apparatus according to the thirteenth aspect, wherein the relief valve is built in a pump unit including the pump and the reservoir.

In a fifteenth aspect, the present invention provides the imaging apparatus according to the thirteenth or fourteenth aspect, wherein said control device controls, to stop the lowering object to be elevated, so as to restore the discharge flow rate to the same flow rate as the predetermined flow rate and close the first opening/closing valve and the second opening/closing valve.

In a sixteenth aspect, the present invention provides the imaging apparatus according to any one of the thirteenth to fifteenth aspects, wherein said control device controls, to lift the object to be elevated, so as to open the first opening/closing valve in a closed state of the second opening/closing valve thereby discharge the fluid from the pump to increase the amount of the fluid held in the cylinder.

In a seventeenth aspect, the present invention provides the imaging apparatus according to any one of the thirteenth to sixteenth aspects, wherein the table moving section further including a check valve for making the fluid flow direction to the direction extending from the first opening/closing valve to the cylinder, which is provided on the second flow path between the first opening/closing valve and the cylinder and sets.

In an eighteenth aspect, the present invention provides the imaging apparatus according to any one of the twelfth to seventeenth aspects, wherein said control device controls the object to be elevated, based on at least one input information of a direction, an amount, a position and a velocity of the object to be elevated to be moved.

In a nineteenth aspect, the present invention provides the imaging apparatus according to any one of the twelfth to eighteenth aspects, wherein the pump is a gear pump.

In a twentieth aspect, the present invention provides the imaging apparatus according to any one of the twelfth to nineteenth aspects, wherein the imaging device has a scan section which scans the subject moved into the imaging space, and wherein the scan section includes a radiation unit which applies radiation to the subject, and a detection unit which detects the radiation applied from the radiation unit and penetrated through the subject.

According to the elevating device of the present invention, a pump and a cylinder are connected to each other by a flow path, and the cylinder and a reservoir are connected to each other by a flow path through a fixed flow valve that causes fluid to flow at a predetermined flow rate. When a lowering operation of an object to be elevated is carried out, control device brings a flow rate of discharge of fluid by the pump and a flow rate of the fluid returned to the reservoir through the fixed flow valve into equilibrium. Thereafter, said control device performs control in such a manner that the flow rate of discharge of the fluid by the pump is set smaller than the predetermined flow rate to reduce the amount of the fluid held in the cylinder. It is therefore possible to gently reduce the amount of the fluid held in the cylinder using the pump originally essential for fluid control and the fixed flow valve lower in cost than a proportional control valve. Thus, a elevating device based on fluid control, which is small in impact at the lowering operation and capable of bringing costs down, can be implemented.

### BRIEF DESCRIPTION OF THE DRAWINGS

FIG. 1 is a block diagram showing an overall construction of an exemplary X-ray CT apparatus.

FIG. 2 is a construction diagram showing all essential part of the X-ray CT apparatus shown in FIG. 1.

FIG. 3 is a diagram showing a relationship of layout between an X-ray tube, a collimator, and an X-ray detector in a scan gantry of the X-ray CT apparatus.

FIG. 4 is a construction diagram illustrating a construction of a subject moving section in the X-ray CT apparatus shown in FIG. 1.

FIG. 5 is a construction diagram depicting a construction of an essential part of the subject moving section in the X-ray CT apparatus shown in FIG. 1.

FIG. 6 is a diagram showing a relationship between the number of revolutions of a motor of a pump, the state of opening/closing of a first opening/closing valve, the state of opening/closing of a second opening/closing valve, and time T at an up-and-down operation of a table section in the X-ray CT apparatus shown in FIG. 1.

FIG. 7 is a flow chart showing the operation of moving the table section downward as viewed in the vertical direction in the X-ray CT apparatus shown in FIG. 1.

### DETAILED DESCRIPTION OF THE INVENTION

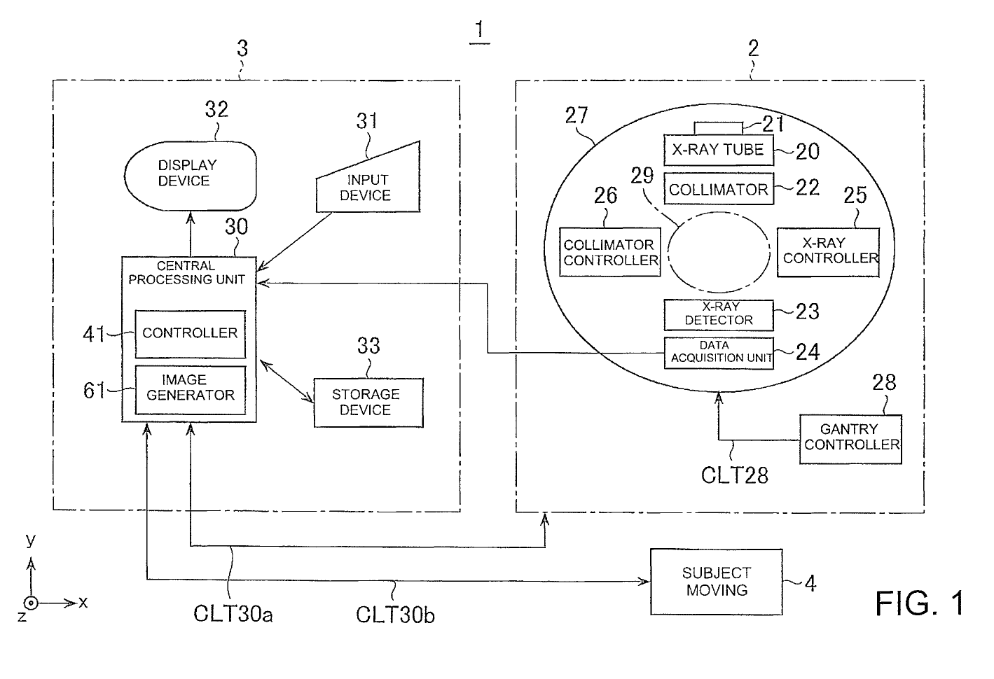

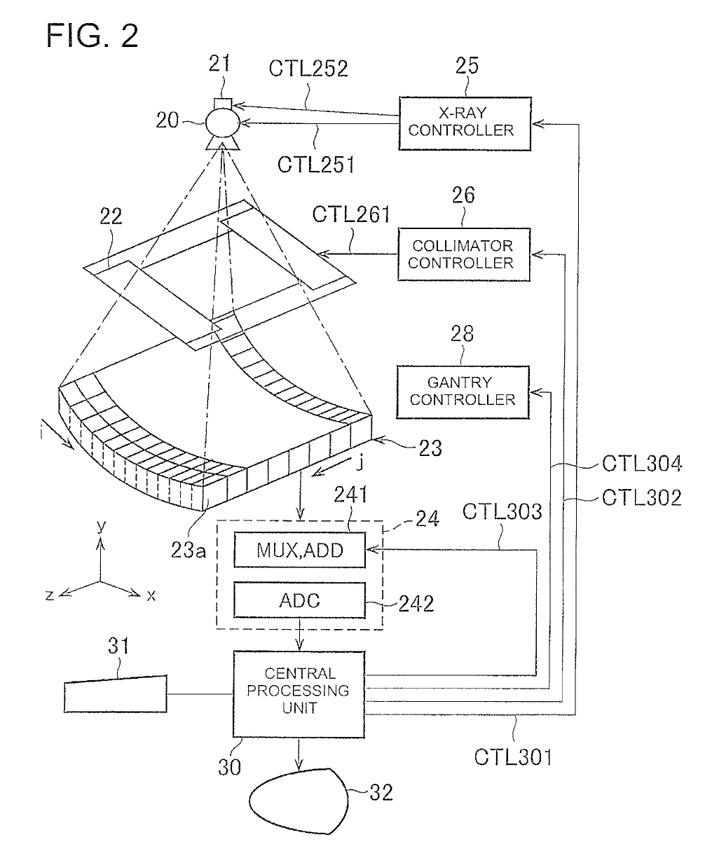

FIG. 1 is block diagram showing an overall construction of an X-ray CT apparatus 1 used as an imaging apparatus illustrative of an embodiment according to the present invention. FIG. 2 is a construction diagram showing an essential part of the X-ray CT apparatus 1 illustrative of the embodiment according to the present invention.

As shown in FIG. 1, the X-ray CT apparatus 1 has a scan gantry 2, an operation console 3 and a subject moving section 4.

The scan gantry 2 has an X-ray tube 20, an X-ray tube moving unit 21, a collimator 22, an X-ray detector 23, a data acquisition unit 24, an X-ray controller 25, a collimator controller 26, a rotating section 27, and a gantry controller 28. The scan gantry 2 scans a subject supported by a table section 101 moved to an imaging space 29 by a table moving unit 102 of the subject moving section 4 to be described later and thereby obtains projection data of the subject as raw data.

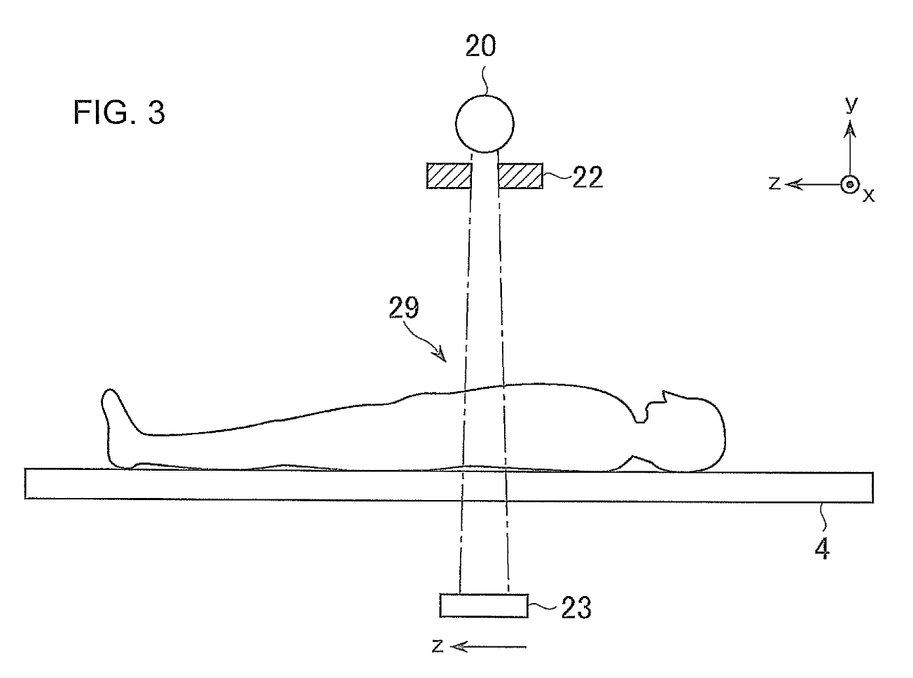

FIG. 3 is a diagram showing a relationship of layout between the X-ray tube 20, the collimator 22 and the X-ray detector 23 in the scan gantry 2.

In the scan gantry 2 as shown in FIG. 3, the X-ray tube 20 and the X-ray detector 23 are disposed so as to sandwich therebetween the imaging space 29 in which the subject is carried and imaging is conducted. The collimator 22 is disposed so as to form X rays applied from the X-ray tube 20.

The respective parts of the scan gantry 2 will be explained.

The X-ray tube 20 is of a rotating anode type, for example and applies X rays. As shown in FIG. 2, the X-ray tube 20 applies X rays of a predetermined intensity to an imaging region of the subject via the collimator 22, based on a control signal CTL251 outputted from the X-ray controller 25. The X rays radiated from the X-ray tube 20 are shaped in the form of, for example, a cone by the collimator 22 and applied to the X-ray detector 23. The X-ray tube 20 is rotated around the subject about a body-axis direction z of the subject by the rotating section 27 to apply the X rays from each peripheral view direction of the subject.

As shown in FIG. 2, the X-ray tube moving unit 21 moves the center of radiation of the X-ray tube 20 in the body-axis direction z of the subject lying within the imaging space 29 in the scan gantry 2, based on a control signal CTL252 outputted from the X-ray controller 25.

As shown in FIG. 2, the collimator 22 is disposed between the X-ray tube 20 and the X-ray detector 23. The collimator 22 is made up of plates respectively provided two by two in a channel direction i and a column direction j, for example. The collimator 22 moves the two plates provided in the respective directions independently, based on a control signal CTL261 outputted from the collimator controller 26 and blocks the X rays irradiated from the X-ray tube 20 with respect to the respective directions to form the same in cone form, thereby adjusting a radiation range of the X rays.

The X-ray detector 23 detects the X rays which are applied from the X-ray tube 20 and transmitted through the subject and thereby generates projection data of the subject. The X-ray detector 23 is rotated around the subject together with the X-ray tube 20 by means of the rotating section 27. The X-ray detector 23 detects the X rays radiated from around the subject and transmitted therethrough to produce projection data.

As shown in FIG. 2, the X-ray detector 23 comprises a plurality of detecting elements 23a. In the X-ray detector 23, the detecting elements 23a are two-dimensionally arranged in array form in the channel direction i extending along the direction in which the X-ray tube 20 is rotated around the subject by the rotating section 27 about the body-axis direction z of the subject, and the column direction j extending along the direction of an rotational axis used as a central axis when the X-ray tube 20 is rotated by the rotating section 27. The X-ray detector 23 has surfaces bent or curved in a cylindrical concave fashion, which are formed by the two-dimensionally arranged detecting elements 23a.

Each of the detecting elements 23a that constitute the X-ray detector 23 has, for example, a scintillator (not shown) which converts the X rays to light, and a photodiode (not shown) which converts the light converted by the scintillator to an electrical charge. The X-ray detector 23 is configured as a solid-state detector. Incidentally, the detecting elements 23a are not limited to the above and may be, for example, semiconductor detecting elements using cadmium telluride (CdTe) or the like or ionization-chamber type detecting elements 23a using xenon gas (Xe gas).

The data acquisition unit 24 is provided to collect or acquire the projection data outputted from the X-ray detector 23. The data acquisition unit 24 acquires the projection data detected by the detecting elements 23a of the X-ray detector 23 and outputs the same to the operation console 3. As shown in FIG. 2, the data acquisition unit 24 has a selection/addition switching circuit (MUX, ADD) 241 and an analog-digital converter (ADC) 242. The selection/addition switching circuit 241 selects projection data detected by the detecting elements 23a of the X-ray detector 23 in response to a control signal CTL303 sent from a central processing unit 30 or adds the same together by changing their combinations and outputs the result thereof to the analog-digital converter 242. The analog-digital converter 242 converts the projection data selected by the selection/addition switching circuit 241 or added up by an arbitrary combination from an analog signal to a digital signal, and outputs the same to the central processing unit 30.

As shown in FIG. 2 the X-ray controller 25 outputs a control signal CTL251 to the X-ray tube 20 in response to a control signal CTL301 outputted from the central processing unit 30 to control the irradiation of X rays. The X-ray controller 25 controls, for example, a tube current value or the like supplied to the X-ray tube 20. Further, the X-ray controller 25 outputs a control signal CTL252 to the X-ray tube moving unit 21 in response to the control signal CTL301 outputted from the central processing unit 30 and controls the center of radiation of the X-ray tube 20 such that it is moved in the body-axis direction z.

As shown in FIG. 2, the collimator controller 26 outputs a control signal CTL261 to the collimator 22 in response to a control signal CTL302 outputted from the central processing unit 30 and controls the collimator 22 in such a manner that the X rays radiated from the X-ray tube 20 are formed.

As shown in FIG. 1, the rotating section 27 is cylindrical in shape and has the imaging space 29 formed thereinside. The rotating section 27 is rotated around the subject about the body-axis direction z of the subject in the imaging space 29 in response to a control signal CTL28 outputted from the gantry controller 28. The rotating section 27 is equipped with the X-ray tube 20, X-ray tube moving unit 21, collimator 22, X-ray detector 23, data acquisition unit 24, X-ray controller 25 and collimator controller 26. A relationship of position between the subjected carried in the imaging space 29 and the respective pants changes relatively in the direction of rotation of the rotating section 27. With the rotation of the rotating section 27, the X-ray tube 21 is capable of applying X rays to the subject every plural views from around the subject, and the X-ray detector 23 is capable of detecting the X rays transmitted or penetrated through the subject every view direction. The rotating section 27 is tilted in response to the control signal CTL28 outputted from the gantry controller 28. The rotating section 27 is slanted along the body-axis direction z about the isocenter of the imaging space 29.

As shown in FIGS. 1 and 2, the gantry controller 28 outputs a control signal CTL28 to the rotating section 27, based on a control signal CTL304 outputted from the central processing unit 30 of the operation console 3 and thereby controls the rotating section 27 in such a manner that it is rotated and tilted.

The operation console 3 will be explained.

As shown in FIG. 1, the operation console 3 has the central processing unit 30, an input device 31, a display device 32 and a storage device 33.

The central processing unit 30 is constituted by a computer, for example and has a controller 41 and an image generator 61 as shown in FIG. 1.

The controller 41 is provided to control the respective parts. For example, the controller 41 receives a scan condition inputted to the input device 31 by an operator and outputs a control signal CTL30a to the respective parts, based on the scan condition to execute scans. Described specifically, the controller 41 outputs a control signal CTL30b to the subject moving section 4 to cause the subject moving section 4 to move the subject to the imaging space 29. Then, the controller 41 outputs a control signal CTL304 to the gantry controller 28 to rotate the rotating section 27 of the scan gantry 2. The controller 41 outputs a control signal CTL301 to the X-ray controller 25 in such a manner that X rays are radiated from the X-ray tube 20. The controller 41 outputs a control signal CTL302 to the collimator controller 26 to control the collimator 22, thereby forming X rays. The controller 41 outputs a control signal CTL303 to the data acquisition unit 24 and controls the data acquisition unit 24 in such a manner that it acquires projection data obtained by the detecting elements 23a of the X-ray detector 23.

The image generator 61 reconstructs all image about each tomographic plane of the subject, based on the projection data acquired by the data acquisition unit 24 of the scan gantry 2. The image generator 61 effects preprocessing such as a sensitivity correction, a beam hardening correction, etc. on projection data from a plurality of axial-based view directions and thereafter performs reconstruction thereon by a filter processing backprojection method, thereby generating an image about each tomographic plane of the subject by the reconstruction.

The input device 31 of the operation console 3 is constituted by an input device such as a keyboard, a mouse or the like. The input device 31 inputs various information Such as a scan condition, an image of a subject, etc. to the central processing unit 30, based on the input operation of the operator.

The display device 32 displays the image about the tomographic plane of the subject, which has been reconstructed by the image generator 61, based on a command issued from the central processing unit 30.

The storage device 33 is made up of a memory and stores therein various data such as an image about each tomographic plane of a subject, which is reconstructed by the image generator 61, etc., programs and the like. In the storage device 33, the data stored therein are accessed by the central processing unit 30 as needed.

The subject moving section 4 will be explained.

The subject moving section 4 is provided to move the subject between the inside of the imaging space 29 and the outside thereof. The subject moving section 4 executes the operation of moving the subject, based on the control signal CTL30b outputted from the central processing unit 30.

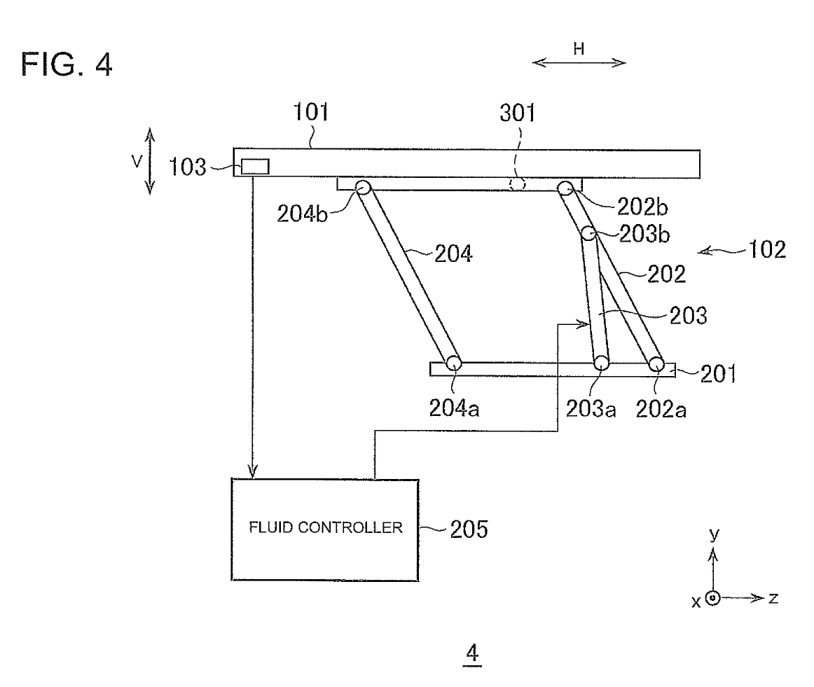

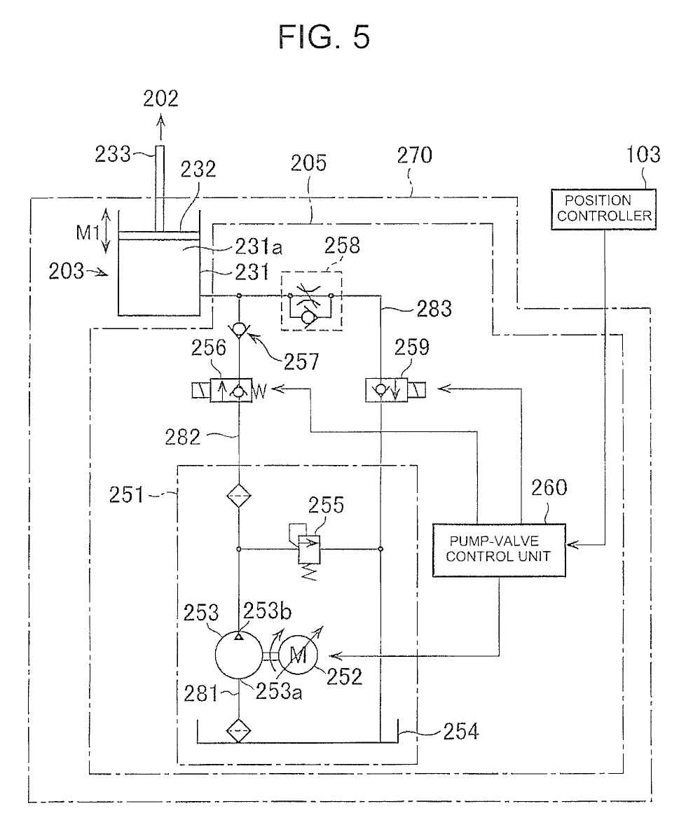

FIGS. 4 and 5 are diagrams showing the subject moving section 4. Here, FIG. 4 is a construction diagram showing a construction of the subject moving section 4. FIG. 5 is a construction diagram showing a construction of all essential part of the subject moving section 4.

As shown in FIG. 4, the subject moving section 4 has a table section 101, a table moving section 102 and a position detector 103. The respective parts will be explained sequentially.

The table section 101 is provided to support the subject. The table section 101 includes a table and is formed with a mounting or placement surface on which the subject is placed. As shown in FIG. 4, the table section 101 is moved in both a horizontal direction H extending along the body-axis direction z of the subject placed on the placement surface, and a vertical direction V corresponding to a gravitational direction orthogonal to the horizontal plane by the table moving section 102 and carried in the imaging space 29.

The table moving section 102 is provided to move the table section 101. The table moving section 102 moves the table section 101 between the inner side of the imaging space 29 and its outer side. As shown in FIG. 4, the table moving section 102 includes a bottom plate 201, a first support bar 202, an actuator 203, a second support bar 204, a fluid controller 205 and a horizontal moving unit 301.

The bottom plate 201 is provided and fixed below from the table section 101 as viewed in the vertical direction.

The first support bar 202 is a bar-like link member and includes a first shaft 202a provided at one end thereof and a second shaft 202b provided at the other end thereof. The first shaft 202a provided at one end of the first support bar 202 is pivotally supported on the bottom plate 201. The first support bar 202 is formed so as to be rotated and moved about the first shaft 202a. The second shaft 202b provided at the other end of the first support bar 202 is pivotally supported on the table section 101. The first support bar 202 is formed in such a manner that it is rotated and moved about the second shaft 202b. Thus, the first support bar 202 supports the table section 101 with the second shaft 202b provided at the other end thereof.

The actuator 203 is a device or equipment mechanically operated using energy based on fluid. As shown in FIG. 4, the actuator 203 moves the table section 101 in the vertical direction V and the horizontal direction H. The actuator 203 has a third shaft 203a provided at one end thereof and a fourth shaft 203b provided at the other end thereof. The third shaft 203a provided at one end of the actuator 203 is pivotally supported on the bottom plate 201. The actuator 203 is formed so as to be rotated and moved about the third shaft 203a. The fourth shaft 203b provided at the other end of the actuator 203 is pivotally supported on the first support bar 202. The actuator 203 and the first support bar 202 are formed so as to be rotated and moved about the fourth shaft 203b. Here, the fourth shaft 203b provided at the other end thereof is pivotally supported so as to be located on the table section 101 than the center of the first support bar 202. The actuator 203 expands and contracts depending on the amount of fluid held thereinside thereby to rotate and move the first support bar 202 about the first shaft 202a and to move the table section 101 in the vertical direction V and the horizontal direction H respectively. At this time, the actuator 203 is also rotated and moved about the third shaft 203a along the direction in which the table section 101 is rotated and moved.

As shown in FIG. 5, the actuator 203 includes a cylinder 231, a piston 232 and a connecting rod 233.

The cylinder 231 holds fluid 231a thereinside and accommodates therein the piston 232 that reciprocates inside the cylinder 231 according to the amount of the fluid 231a. The cylinder 231 is pivotally supported on the bottom plate 201 by the third shaft 203a. The cylinder 231 holds oil therein as the fluid 231a. In the cylinder 231, the amount of the fluid 231a held thereinside is controlled by the fluid controller 205.

The piston 232 is accommodated in the cylinder 231. The piston 232 reciprocates inside the cylinder 231 depending on the amount of the fluid 231a held by the cylinder 231. As indicated by arrow M1 shown in FIG. 5 by way of example, the piston 232 reciprocates inside the cylinder 231. When the amount of the fluid 231a held in the cylinder 231 increases, the piston 232 moves along the direction in which the fluid 231a increases in the cylinder 231, and moves the table section 101 upwards as viewed in the vertical direction V. When the amount of the fluid 231a held in the cylinder 231 decreases, the piston 232 moves along the direction in which the fluid 231a decreases in the cylinder 231, and moves the table section 101 downwards as viewed in the vertical direction V.

The connecting rod 233 is provided so as to connect the piston 232 and the first support bar 202. The connecting rod 233 is pivotally supported on the first support bar 202 by the fourth shaft 203b and transfers reciprocating motion of the piston 232 to the first support bar 202 to rotate and move the first support bar 202.

As shown in FIG. 4, the second support bar 204 of the table moving section 102 is a bar-like link member. The second support bar 204 has a fifth shaft 204a provided at one end thereof and a sixth shaft 204b provided at the other end thereof. The fifth shaft 204a provided at one end of the second support bar 204 is pivotally supported on the bottom plate 201. The second support bar 204 is formed so as to be rotated and moved about the fifth shaft 204a. The sixth shaft 204b provided at the other end of the second support bar 204 is pivotally provided on the table section 101. The second support bar 204 is formed so as to be rotated and moved about the sixth shaft 204b. Thus, the second support bar 204 supports the table section 101 with the sixth shaft 204b provided at the other end. The second support bar 204 is identical in length to the first support bar 202. Even when the table section 101 is moved in the vertical direction V, the second support bar 204 is formed so as to be parallel in its longitudinal direction with the first support bar 202.

The fluid controller 205 of the table moving section 102 adjusts the amount of the fluid injected into the cylinder 231 of the actuator 203 and the amount of the fluid discharged from the cylinder 231 thereby to control the amount of the fluid 231a lying inside the actuator 203.

Incidentally, the cylinder 231 of the actuator 203 and the fluid controller 205 constitute a lifting or elevating/lowering device 270.

As shown in FIG. 5, the fluid controller 205 has a reservoir or reservoir 254 which retains or reserves fluid therein, a pump 253 having a suction port or opening 253a and a delivery or discharge port or opening 253b, a motor 252 which drives the pump 253, the cylinder 231 which causes the table section 101 to move up and down depending on the amount of the fluid held therein, a first channel or flow path 281 which connects the reservoir 254 and the suction port 253a of the pump, a second flow path 282 which connects the discharge port 253b of the pump and the cylinder 231, a third flow path 283 which connects the cylinder 231 and the reservoir 254, a fixed flow valve 258 for causing the fluid to flow at a constant flow rate, which is provided on the third flow path 283, a first opening/closing valve 256 provided on the second flow path 282, a one-way valve 257 for setting the direction in which the fluid flows, to the direction from the first opening/closing valve 256 to the cylinder 254, which is provided on the second flow path 283 between the first opening/closing valve 256 and the cylinder 254, a second opening/closing valve 259 provided on the third flow path 283, a relief valve 255 provided between the discharge port 253b of the pump and the reservoir 254 via a flow path, and a pump-valve control unit 260 which controls the pump and the opening/closing valves.

Incidentally, the motor 252, pump 253, reservoir 254 and relief valve 255 are built in a pump unit 251.

When the pump 253 is driven by the motor 252, it sucks the fluid from the suction port 253a and discharges it from the discharge port 253b. Though, for example, a centrifugal pump, a turbine pump, a plunger pump, a diaphragm pump, a gear pump or the like can be considered as the type of pump, the gear pump in which a pulsating flow at the flow of the discharged or delivered fluid is relatively small and which is small in size and easy to handle, is suitable for such a pump. The pump 253 discharges the fluid at a flow rate proportional to the number of revolutions of the motor 252, e.g., a flow rate of 1 cc per rotation of the motor,

The reservoir 254 is a so-called tank that reserves the fluid therein. The reservoir 254 is connected to the discharge port 253a of the pump 253. When the motor 252 of the pump 253 is driven, the fluid reserved in the reservoir 254 is sucked into the suction port 253a of the pump 253.

The relief valve 255 is one type of escape valve. For example, when pressure in a predetermined direction does not exceed set pressure, the relief valve 255 closes, whereas when it exceeds the same, the relief valve 255 opens in proportion to its excess pressure. The relief valve 255 is normally often built in a pump unit in advance for safety's sake. Here, the relief valve 255 is built in the pump unit 251 and connected between the discharge port 253b of the pump 253 and the reservoir 254. That is, when pressure from the discharge port 253b side to the reservoir 254 side exceeds the set pressure, the relief valve 255 is opened so that the fluid flows from the discharge port 253b side of the pump to the reservoir 254 side.

The first opening/closing valve 256 is a valve that opens and closes in response to a control signal outputted from the pump-valve control unit 260 and is also called “shut valve”. Though, for example, an electric operated valve, an air-motor valve, a cylinder valve, a solenoid control valve or the like can be considered as the type of opening/closing valve, the solenoid control valve, which is easy to produce a control signal and inexpensive, e.g., a poppet valve is suitable for such an opening/closing valve. The first opening/closing valve 256 is connected between the discharge port 253b of the pump 253 and the cylinder 231. When the first opening/closing valve 256 is open, the fluid discharged from the pump 253 flows into the cylinder 231 side through the first opening/closing valve 256. When the first opening/closing valve 256 is closed, the fluid flows into the reservoir 254 side through the relief valve 255.

The one-way valve 257 is a valve that causes fluid to flow in one direction and makes little its flow in the opposite direction. The one-way valve 257 is also called “check valve”. The check valve 257 is connected between the first opening/closing valve 256 and the cylinder 231 and sets the direction in which the fluid flows, to the direction from the first opening/closing valve 256 to the cylinder 231. Thus, the check valve 257 prevents the fluid 231a held in the cylinder 231 from reversely flowing to the discharge port 253b side of the pump 253.

The fixed flow valve 258 is a valve that holds the flow rate of fluid at a predetermined flow rate even though the pressure of the fluid varies when the fluid flows. The second opening/closing valve 259 is a valve that opens and closes in response to a control signal outputted from the pump-valve control unit 260 in a manner similar to the first opening/closing valve 256. The fixed flow valve 258 and the second opening/closing valve 259 are connected in series between the cylinder 231 and the reservoir 254. When the second opening/closing valve 259 is opened, the fluid 231a held in the cylinder 231 and the fluid delivered from the pump 253 are discharged into the reservoir 254 at the predetermined flow rate defined by the fixed flow valve 258.

When the table section 101 is caused to move up and down, the pump-valve control unit 260 controls the pump 253, the first opening/closing valve 256 and the second opening/closing valve 259 to adjust the amount of the fluid 231a held in the cylinder 231. Described specifically, the pump-valve control unit 260 performs the following control.

Incidentally, although not shown in the drawing, the neighborhood of an upper end of the cylinder 231 and the reservoir 254 are connected to each other, and a flow path is provided which returns fluid that has leaked out from a gap defined between the cylinder 231 and the piston 232, to the reservoir 254.

When the table section 101 is elevated, the pump-valve control unit 260 sends a control signal to the first opening/closing valve 256 in such a manner that the first opening/closing valve 256 is opened in a state in which the second opening/closing valve 259 is being closed. At this time, the fluid 231a held in the cylinder 231 is not discharged into the reservoir 254 side because the second opening/closing valve 259 is closed. With the action of the check valve 257, the fluid 231a does not reversely flows into the discharge port 253b side of the pump 253. Next, the pump-valve control unit 260 drives the motor of the pump 253 to discharge the fluid from the pump 253. The fluid discharged by the pump 253 is not discharged to the reservoir 254 side because the second opening/closing valve 259 is being closed, but supplied to the cylinder 231. Thus, the amount of the fluid 231a held in the cylinder 231 increases, thereby elevating the table section 101. When the number of revolutions of the motor 252 of the pump 253 is increased slowly from zero at this time, the table section 101 starts to move upward or lift slowly without impact. Thereafter, the number of the revolutions of the motor 252 is adjusted to make it possible to control the speed at which the table section 101 lifts.

When the elevating table section 101 is stopped, the pump-valve control unit 260 controls the number of revolutions of the motor 252 of the pump 253 in such a manner that the flow rate of discharge of the fluid by the pump 253 is lowered to zero. When the flow rate of discharge of the fluid by the pump 253 reaches zero, the flow rate of the fluid supplied to the cylinder 231 side is brought to zero so that the table section 101 is stopped. Next, the pump-valve control unit 260 sends a control signal to the first opening/closing valve 256 to close the first opening/closing valve 256.

When the table section 101 is lowered, the pump-valve control unit 260 first controls the number of revolutions of the motor 252 of the pump 253 in such a manner that the flow rate of discharge of the fluid by the pump 253 is adjusted to the same flow rate as the predetermined flow rate defined by the fixed flow valve 258 in a state in which the first opening/closing valve 256 and the second opening/closing valve 259 are being closed. The fluid discharged by the pump 253 is not supplied to the cylinder 231 side because the first opening/closing valve 256 is closed, and the pressure of the fluid in the corresponding flow path connected to the discharge port 253b of the pump 253 rises. Consequently, the relief valve 255 is opened and thereby the fluid discharged by the pump 253 flows into the reservoir 254 via the relief valve 255. Next, the pump-valve control unit 260 sends a control signal to the first opening/closing valve 256 and the second opening/closing valve 259 to open the first opening/closing valve 256 and the second opening/closing valve 259. Thus, the fluid discharged from the pump 253 flows into the cylinder 231 side through the first opening/closing valve 256 and returns to the reservoir 254 through the fixed flow valve 258 and the second opening/closing valve 259. At this time, the flow rate of discharge of the fluid by the pump 253 and the flow rate of the fluid that flows through the fixed flow valve 258 and returns to the reservoir 254, are identical and brought into equilibrium. While the flow rate of discharge of the fluid by the pump 253 and the flow rate of the fluid that flows through the fixed flow valve 258 are being in equilibrium, the amount of the fluid 231a held in the cylinder 231 does not change. That is, the table section 101 remains stopped. Then, the pump-valve control unit 260 reduces the number of revolutions of the motor 252 of the pump 253 in such a mariner that the flow rate of discharge of the fluid by the pump 253 becomes smaller than the predetermined flow rate. Consequently, the flow rate of the fluid discharged to the reservoir 254 exceeds the flow rate of the fluid supplied to the cylinder 231 side, and the amount of the fluid 231a held in the cylinder 231 decreases, whereby the table section 101 is lowered. When the number of revolutions of the motor 252 of the pump 253 is slowly lowered from the number of revolutions corresponding to the predetermined flow rate at this time, the table section 101 starts to move downward or lower slowly without impact. Thereafter, the lowering speed of the table section 101 can be adjusted by adjusting the number of revolutions of the motor.

When the lowering table section 101 is stopped, the pump-valve control unit 260 increases the number of revolutions of the motor 252 of the pump 253 to restore the flow rate of discharge of the fluid by the pump 253 to the same flow rate as the predetermined flow rate defined by the fixed flow valve 258. When the flow rate of discharge of the fluid by the pump 253 is brought to the same flow rate as the predetermined flow rate, the flow rate of the fluid supplied to the cylinder 231 side and the flow rate of the fluid discharged to the reservoir 254 are brought into equilibrium again so that the table section 101 is stopped. Next, the pump-valve control unit 260 sends a control signal to the first opening/closing valve 256 and the second opening/closing valve 259 to close the first opening/closing valve 256 and the second opening/closing valve 259. The pump-valve control unit 260 reduces the number of revolutions of the motor 252 of the pump 253 to zero in such a manner that the flow rate of discharge of the fluid by the pump 253 is lowered to zero.

Incidentally, the pump-valve control unit 260 executes the control on the above elevating or up-and-down operation of the table section 101, based on the direction, amount, position, speed and the like of the table section 101 to be moved, which have been set by an operator or the like. For instance, the pump-valve control unit 260 sets the direction of the table section 101 to be moved and the amount of its movement from information indicative of a destination of the table section 101 inputted by the operator via the input device 31 and performs control on the elevating operation while monitoring the position in the vertical direction V, of the table section 101, which has been detected by the position detector 103, based on the direction and the amount of the movement referred to above. For example, the pump-valve control unit 260 sets the direction of the table section 101 to be moved and its moving speed from the type of an elevating button pressed by the operator and the time required to press it on the input device 31 or an operation or control device additionally provided in the subject moving section 4 or the like, and performs control on the elevating operation, based on the direction and the speed referred to above.

Examples will now be shown as to the number of revolutions of the motor 252 of the pump 253 and the operations of the first opening/closing valve 256 and the second opening/closing valve 259 at the time that the table section 101 is moved upward and downward at high speed, low speed and inching.

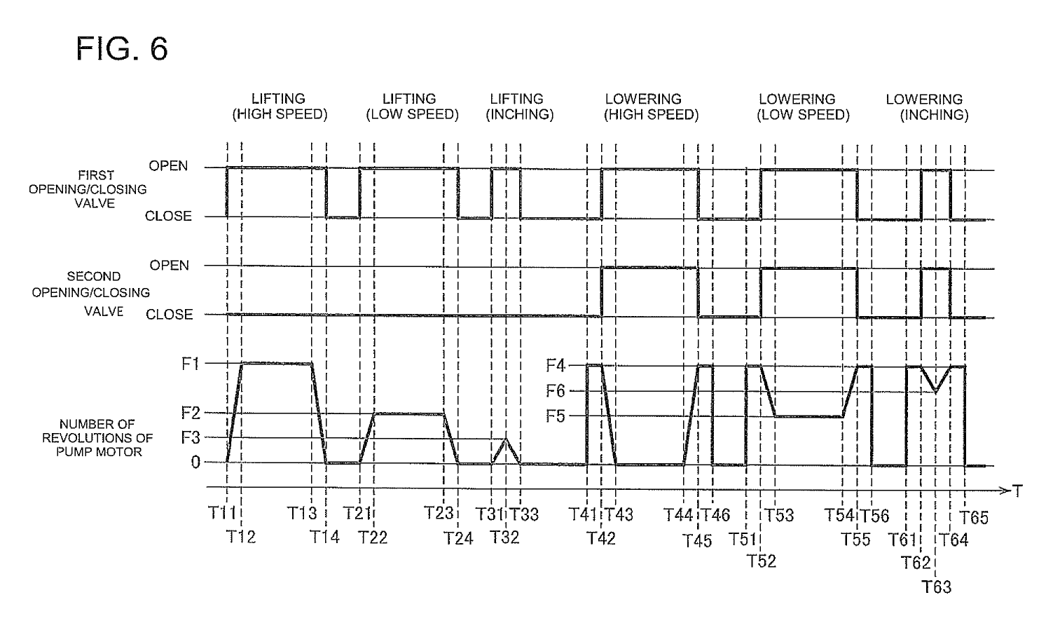

FIG. 6 is a diagram showing an example of a relationship between the number of revolutions of the motor 252 of the pump 253, the state of opening/closing of the first opening/closing valve 256, the state of opening/closing of the second opening/closing valve 259 and time T at the elevating operation of the table section 101. Incidentally, these are predicated on the fact that the elevating operation is started in a state in which the first opening/closing valve 256 and the second opening/closing valve 259 are closed and the motor 252 of the pump 253 is being stopped.

A description will be made of a case in which the table section 101 is elevated at high speed. At a time T11 at which the lifting operation of the table section 101 is started, as shown in FIG. 6, the pump-valve control unit 260 opens the first opening/closing valve 256 and drives the motor 252 of the pump 253 to start to increase the number of revolutions thereof from zero. Thereafter, the pump-valve control unit 260 increases the number of revolutions of the motor 252 gradually. Thus, the amount of the fluid 231a held in the cylinder 231 increases slowly and the table section 101 lifts gently and accelerates. At a time T12 after a predetermined time has elapsed from the time T11, the number of revolutions of the motor 252 reaches the high-speed number of revolutions F1. Here, the pump-valve control unit 260 holds the number of revolutions of the motor 252. Consequently, the amount of the fluid 231a held in the cylinder 231 continues to increase at a predetermined rate and thereby the table section 101 continues to lift at a predetermined velocity V1. At a time T13 subsequent to the elapse of a predetermined time from the time T12, the pump-valve control unit 260 starts to reduce the number of revolutions of the motor 252. Thereafter, the pump-valve control unit 260 gradually reduces the number of revolutions of the motor 252. Thus, the rate of increase in the amount of the fluid 231a held in the cylinder 231 decreases slowly, and hence the table section 101 decelerates slowly. At a time T14 after a predetermined time has elapsed from the time T13, the number of revolutions of the motor 252 is brought to zero so that the supply of the fluid to the cylinder 231 is stopped, whereby the table section 101 is stopped. Here, the pump-valve control unit 260 closes the first opening/closing valve 256.

A description will next be made of a case in which the table section 101 is elevated at low speed. At a time T21 at which the lifting operation of the table section 101 is started, as shown in FIG. 6, the pump-valve control unit 260 opens the first opening/closing valve 256 and starts to increase the number of revolutions of the motor 252 of the pump 253 from zero. Thereafter, the pump-valve control unit 260 gradually raises the number of revolutions of the motor 252 of the pump 253. Thus, the amount of the fluid 231a field in the cylinder 231 starts to increase slowly, and the table section 101 gently lifts and accelerates. At a time T22 subsequent to the elapse of a predetermined time from the time T21, the number of revolutions of the motor 252 reaches the low-speed number of revolutions F2 (<F1). Here, the pump-valve control unit 260 holds the number of revolutions of the motor. Consequently, the amount of the fluid 231a held in the cylinder 231 continues to increase at a predetermined rate and the table section 101 continues to lift at a predetermined velocity V2 (<V1). At a time T23 after a predetermined time has elapsed from the time T22, the pump-valve control unit 260 starts to reduce the number of revolutions of the motor 252. Thereafter, the pump-valve control unit 260 gradually reduces the number of revolutions of the motor 252. Thus, the rate of increase in the amount of the fluid 231a held in the cylinder 231 decreases gently and the table section 101 decelerates gently. At a time T24 subsequent to the elapse of a predetermined time from the time T23, the number of revolutions of the motor 252 reaches zero so that the supply of the fluid to the cylinder 231 is stopped, whereby the table section 101 is stopped. Here, the pump-valve control unit 260 closes the first opening/closing valve 256.

A description will next be made of a case in which the table section 101 is elevated at inching. At a time T31 at which the lifting operation of the table section 101 is started, as shown in FIG. 6, the pump-valve control unit 260 opens the first opening/closing valve 256 and starts to raise the number of revolutions of the motor 252 of the pump 253 from zero. Thereafter, the pump-valve control unit 260 gradually raises the number of revolutions of the motor 252. Consequently, the amount of the fluid 231a held in the cylinder 231 increases gently and the table section 101 gently lifts and accelerates. At a time T32 after a predetermined time has elapsed from the time T31, the number of revolutions of the motor 252 reaches the number of revolutions F3 (<F2). Here, the pump-valve control unit 260 starts to reduce the number of revolutions of the motor 252. Thereafter, the pump-valve control unit 260 gradually reduces the number of revolutions of the motor. Consequentially, the rate of increase in the amount of the fluid 231a held in the cylinder 231 decreases gently and the table section 101 decelerates gently. At a time T33 subsequent to the elapse of a predetermined time from the time T32, the number of revolutions of the motor 252 is brought to zero so that the supply of the fluid to the cylinder 231 is stopped, whereby the table section 101 is stopped. Here, the pump-valve control unit 260 closes the first opening/closing valve 256.

A description will next be made of a case in which the table section 101 is lowered at high speed. At a time T41 at which the lowering operation of the table section 101 is started, as shown in FIG. 6, the pump-valve control unit 260 increases the number of revolutions of the motor 252 of the pump 253 to a high speed and holds it at a predetermined number of revolutions. The predetermined number of revolutions corresponds to such a number of revolutions F4 that the flow rate of fluid discharged from the pump 253 becomes the same flow rate as the predetermined flow rate defined by the fixed flow valve 258. The number of revolutions of the motor immediately reaches the number of revolutions F4. At this time, the fluid discharged from the pump 253 is returned to the reservoir 254 via the relief valve 255 as mentioned above. At a time T42 subsequent to the elapse of a predetermined time from the time T41, the number of revolutions of the motor 252 is stabilized. Here, the pump-valve control unit 260 opens the first opening/closing valve 256 and the second opening/closing valve 259 simultaneously. At this time, the flow rate of the fluid discharged from the pump 253 and the flow rate of the fluid discharged to the reservoir 254 through the fixed flow valve 258 are in equilibrium. Thereafter, the pump-valve control unit 260 gradually reduces the number of revolutions of the motor 252. Thus, the flow rate of the fluid discharged from the pump 253 decreases gently and the amount of the fluid 231a held in the cylinder 231 decreases gently. Hence the table section 101 is lowered gently and accelerated gradually. At a time T43 after a predetermined time has elapsed from the time T42, the number of revolutions of the motor 252 is brought to zero and hence the flow rate of the fluid discharged from the pump 253 reaches zero. The fluid 231a held in the cylinder 231 is discharged to the reservoir 254 at a predetermined flow rate defined by the fixed flow valve 258. At this time, the amount of the fluid 231a held in the cylinder 231 continues to decrease at a predetermined rate, and the table section 101 continues to lowered at a predetermined velocity V4. At a time T44 after a predetermined time has elapsed from the time 143, the pump-valve control unit 260 gradually raises the number of revolutions of the motor. Consequently, the table section 101 decelerates gently. At a time T45 subsequent to the elapse of a predetermined time from the time T44, the number of revolutions of the motor 252 is brought to F4 again, so that the supply and discharge of the fluid to and from the cylinder 231 are stopped, thereby stopping the table section 101. Here, the pump-valve control unit 260 closes the first opening/closing valve 256 and the second opening/closing valve 259. At a time T46 subsequent to the elapse of a predetermined time from the time T45, the pump-valve control unit 260 stops the driving of the motor 252.

A description will next be made of a case in which the table section 101 is lowered at low speed. At a time T51 at which the table section 101 starts its lowering operation, as shown in FIG. 6, the pump-valve control unit 260 increases the number of revolutions of the motor 252 of the pump 253 to a high speed and holds it at a predetermined number of revolutions. As described above, the predetermined number of revolutions corresponds to such a number of revolutions F4 that the flow rate of fluid discharged from the pump 253 becomes the same flow rate as the predetermined flow rate defined by the fixed flow valve 258. The number of revolutions of the motor 252 immediately reaches the number of revolutions F4. At this time, the fluid discharged from the pump 253 is returned to the reservoir 254 via the relief valve 255 as mentioned above. At a time 152 subsequent to the elapse of a predetermined time from the time T51, the number of revolutions of the motor 252 is stabilized. Here, the pump-valve control unit 260 opens the first opening/closing valve 256 and the second opening/closing valve 259 simultaneously. At this time, the flow rate of the fluid discharged from the pump 253 and the flow rate of the fluid discharged to the reservoir 254 through the fixed flow valve 258 are in equilibrium. Thereafter, the pump-valve control unit 260 gradually reduces the number of revolutions of the motor 252. Thus, the flow rate of the fluid discharged from the pump 253 decreases gently and the amount of the fluid 231a held in the cylinder 231 decreases gently. Hence the table section 101 is lowered gently and accelerated gradually. At a time T53 subsequent to the elapse of a predetermined time from the time T52, the number of revolutions of the motor 252 reaches the number of revolutions F3 (<F4), so that the flow rate of the fluid discharged from the pump 253 is brought to a predetermined flow rate corresponding to the number of revolutions F3 of the motor. Hence the fluid 231a held in the cylinder 231 is discharged to the reservoir 254 at a flow rate obtained by subtracting the predetermined flow rate from the predetermined flow rate defined by the fixed flow valve 258. At this time, the amount of the fluid 231a held in the cylinder 231 continues to decrease at a predetermined rate, and the table section 101 continues to lower at a predetermined velocity V5 (<V4). At a time T54 after a predetermined time has elapsed from the time T53, the pump-valve control unit 260 gradually raises the number of revolutions of the motor. Consequently, the table section 101 decelerates gently. At a time T55 subsequent to the elapse of a predetermined time from the time T54, the number of revolutions of the motor 252 is brought to F4 again, so that the supply and discharge of the fluid to and from the cylinder 231 are stopped, thereby stopping the table section 101. Here, the pump-valve control unit 260 closes the first opening/closing valve 256 and the second opening/closing valve 259. At a time T56 subsequent to the elapse of a predetermined time from the time T55, the pump-valve control unit 260 stops the driving of the motor 252.

A description will next be made of a case in which the table section 101 is lowered at inching. At a time T61 at which the lifting operation of the table section 101 is started, as shown in FIG. 6, the pump-valve control unit 260 increases the number of revolutions of the motor 252 of the pump 253 to a high speed and holds it at a predetermined number of revolutions. As described above, the predetermined number of revolutions corresponds to such a number of revolutions F4 that the flow rate of fluid discharged from the pump 253 becomes the same flow rate as the predetermined flow rate defined by the fixed flow valve 258. The number of revolutions of the motor 252 immediately reaches the number of revolutions F4. At this time, the fluid discharged from the pump 253 is returned to the reservoir 254 via the relief valve 255 as mentioned above. At a time T62 subsequent to the elapse of a predetermined time from the time T61, the number of revolutions of the motor 252 is stabilized. Here, the pump-valve control unit 260 opens the first opening/closing valve 256 and the second opening/closing valve 259 simultaneously. At this time, the flow rate of the fluid discharged from the pump 253 and the flow rate of the fluid discharged to the reservoir 254 through the fixed flow valve 258 are in equilibrium. Thereafter, the pump-valve control unit 260 gradually reduces the number of revolutions of the motor 252. Thus, the flow rate of the fluid discharged from the pump 253 decreases and the amount of the fluid 231a held in the cylinder 231 decreases. Hence the table section 101 is lowered gently and accelerated gradually. At a time T63 subsequent to the elapse of a predetermined time from the time T62, the number of revolutions of the motor 252 reaches F6 (<F4 and >F5). Here, the pump-valve control unit 260( starts to increase the number of revolutions of the motor 252. Hence the table section 101 decelerates gently. At a time T64 subsequent to the elapse of a predetermined time from the time T63, the number of revolutions of the motor 252 is brought to F4 again. Here, the pump-valve control unit 260 closes the first opening/closing valve 256 and the second opening/closing valve 259. Hence the supply and discharge of the fluid to and from the cylinder 231 are stopped and thereby the table section 101 is stopped. At a time T65 subsequent to the elapse of a predetermined time from the time T64, the driving of the motor 252 is stopped.

The horizontal moving unit 301 of the table moving section 102 is formed so as to move the table section 101 in the horizontal direction H. The horizontal moving unit 301 is equipped with, for example, a roller type drive mechanism (not shown) and allows a motor (not shown) to drive a roller, thereby moving the table section 101 in the horizontal direction H.

The position detector 103 shown in FIG. 4 is formed so as to detect the position in the vertical direction V, of the table section 101. The position detector 103 includes, for example, a non-contact optical potentiometer. In the position detector 103 as shown in FIG. 4, for example, the optical potentiometer is provided at the end of the table section 101. As shown in FIG. 5, the position detector 103 outputs the result of the position in the vertical direction V, of the table section 101 to the pump-valve control unit 260 of the fluid controller 205.

Incidentally, the X-ray CT apparatus 1 according to the present embodiment corresponds to an imaging apparatus of the present invention. The scan gantry 2 employed in the present embodiment corresponds to a scan section of the present invention. The X-ray tube 20 employed in the present embodiment corresponds to a radiation unit of the present invention. The X-ray detector 23 employed in the present embodiment corresponds to a detection unit of the present invention. The pump-valve control unit 260 employed in the present embodiment corresponds to control device of the present invention.

The operation of the X-ray CT apparatus 1 according to the present embodiment will be explained below.

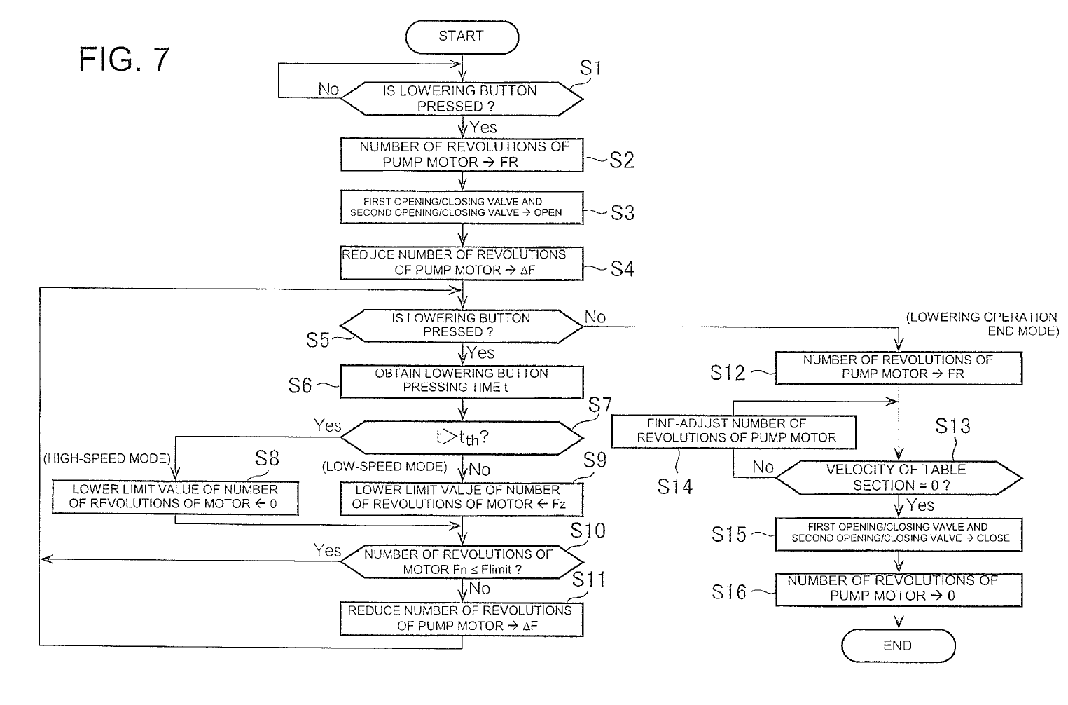

FIG. 7 is a flow chart showing the operation of moving the table section 101 downward as viewed in the vertical direction V, based on pressing of a lowering button by an operator in the X-ray CT apparatus 1 of the present embodiment.

As shown in FIG. 7, the pump-valve control unit 260 determines whether the lowering button is pressed (S1). When it is now determined that the lowering button has been pressed, the pump-valve control unit 260 proceeds to step S2 and enters lowering operation processing. On the other hand, when it is determined that the lowering button is not pressed, the pump-valve control unit 260 returns to step S1 and enters a waiting or standby state until the button is pressed.

When the lowering operation processing is reached, the pump-valve control unit 260 sends a control signal to the motor 252 of the pump 253 in a state in which the first opening/closing valve 256 and the second opening/closing valve 259 are being closed, and raises the number of revolutions of the motor 252 to the number of revolutions FR in such a manner that the flow rate of discharge of fluid by the pump 253 becomes the same flow rate as the predetermined flow rate defined by the fixed flow valve 258 (S2). The pump-valve control unit 260 sends a control signal to the first opening/closing valve 256 and the second opening/closing valve 259 to open these opening/closing valves and to bring the flow rate of discharge of the fluid by the pump 253 and the flow rate of fluid returned to the reservoir 254 through the fixed flow valve 258 into equilibrium (S3). The pump-valve control unit 260 sends a control signal to the motor 252 of the pump 253 to set the flow rate of discharge of the fluid by the pump 253 smaller than the predetermined flow rate, thereby reducing the amount of the fluid 231a held in the cylinder 231. Here, the pump-valve control unit 260 reduces the number of revolutions of the motor 252 by a small rotation ΔF (S4).

The pump-valve control unit 260 determines again whether the lowering button is pressed (S5). When it is now determined that the lowering button is still being pressed, the pump-valve control unit 260 proceeds to step S6 and enters a continuous lowering operation mode. On the other hand, when it is determined that the lowering button has not already been pressed, the pump-valve control unit 260 determines it as being such an inching operation that the lowering button is pressed only for a moment and proceeds to step S12, where it enters a lowering operation end mode.

In the continuous lowering operation mode, the time t_{d} required to press the lowering button is first obtained (S6). The pump-valve control unit 260 determines whether the pressing time t_{d} is greater than a predetermined threshold value tₜₕ (S7). When it is now determined that the pressing time t_{d} is greater than the threshold value tₜₕ, the pump-valve control unit 260 determines that the lowering button has been pressed over a long period of time and enters a high-speed mode to set a lower limit value Fₗᵢₘᵢₜ of the number of revolutions of the motor 252 to zero (S8). On the other hand, when it is determined that the pressing time t_{d} is not greater than the threshold value tₜₕ, the pump-valve control unit 260 determines that the lowering button has not reached its long-time pressing and enters a low-speed mode to set the lower limit value Fₗᵢₘᵢₜ of the number of revolutions of the motor 252 to the number of revolutions Fₘ larger than zero (S9).

Further, the pump-valve control unit 260 determines whether the number of revolutions Fₙ of the motor at the present time is not greater than the lower limit value Fₗᵢₘᵢₜ set at step S9 (S10). When it is now determined that the number of revolutions Fₙ of the motor 252 at the present time is not greater than the lower limit value Fₗᵢₘᵢₜ, the pump-valve control unit 260 determines that the number of revolutions Fₙ of the motor 252 has already reached the lower limit value Fₗᵢₘᵢₜ and returns to step S5. On the other hand, when it is determined that the number of revolutions Fₙ of the motor 252 at the present time is greater than the lower limit value Fₗᵢₘᵢₜ, it is determined that the number of revolutions Fₙ of the motor 252 does not reach the lower limit value Fₗᵢₘᵢₜ. Thus, the pump-valve control unit 260 sends a control signal to the motor of the pump 253 to reduce the number of revolutions of the motor by a small rotation ΔF (S11). The pump-valve control unit 260 returns to step S5.

In the continuous lowering operation mode as described above, the lowering operation can be performed in two stages of a high speed and a low speed according to the pressing time of the lowering button.

On the other hand, when the lowering operation end mode is reached, the pump-valve control unit 260 sends a control signal to the motor 252 of the pump 253 and returns the number of revolutions of the motor 252 to FR (S12). The pump-valve control unit 260 determines based on information about the position of the table section 101, which is obtained from the position detector 103, whether the velocity of the table section 101 is brought to zero (S13). When it is determined at this time that the velocity of the table section 101 does not reach zero, the pump-valve control unit 260 transmits a control signal to the motor 252 in such a manner that the velocity of the table section 101 becomes zero, and thereby fine-adjusts the number of revolutions of the motor 252 (S14). After the number of revolutions of the motor 252 has been fined-adjusted, the pump-valve control unit 260 returns to step S13 again and determines thereat whether the velocity of the table section 101 reaches zero. On the other hand, when the velocity of the table section 101 is found to have reached zero, the pump-valve control unit 260 sends a control signal to the first opening/closing valve 256 and the second opening/closing valve 259 and thereby closes the first opening/closing valve 256 and the second opening/closing valve 259 simultaneously (S15). Thereafter, the pump-valve control unit 260 transmits a control signal to the motor 252 to bring the number of revolutions of the motor 252 to zero, thereby stopping its driving (S16).

According to the present embodiment as described above, the pump 253 and the cylinder 231 are connected to each other by the corresponding flow path or channel. Further, the cylinder 231 and the reservoir 254 are connected to each other by the corresponding flow path through the fixed flow valve 258 that allows fluid to flow at a predetermined flow rate. When the lowering operation of the table section 101 is conducted, the pump-valve control unit 260 brings the flow rate of discharge of the fluid by the pump 253 and the flow rate of the fluid returned to the reservoir 254 through the fixed flow valve 258 into equilibrium. Thereafter, the pump-valve control unit 260 sets the flow rate of discharge of the fluid by the pump 253 smaller than the above predetermined flow rate thereby to control the amount of the fluid held in the cylinder 231 such that it becomes small. It is therefore possible to gently reduce the amount of the fluid held in the cylinder 231 using the pump 253 originally essential for fluid control and the fixed flow valve 258 lower in cost than a proportional control valve. Thus, a elevating device based on fluid control, which is small in impact at the lowering operation and capable of lowering costs, can be realized.

According to the present embodiment, the flow rate of the fluid discharged from the cylinder 231 is adjusted by adjusting the flow rate of discharge of the fluid using the pump capable of controlling the discharge flow rate of the fluid with good accuracy without using the proportional control valve having such a characteristic that the flow rate of the fluid changes depending on the pressure applied to the valve. Therefore, the accuracy of position at the time that the table section 101 is moved up and down is more improved.

According to the present embodiment, the pump unit 251 uses the relief valve 255 originally provided as the safety valve as the escape valve which allows the fluid discharged from the pump 253 to escape at the stage that the flow rate of discharge of the fluid by the pump 253 is brought to the same flow rate as the predetermine flow rate defined by the fixed flow valve 258. It is therefore possible to enhance the utilization efficiency of each part and realize space-saving and a reduction in cost.

Incidentally, the present invention is not limited to the above embodiment upon implementation of the present invention. Various modified forms can be adopted.

Although the above embodiment has explained, for instance, the example of the X-ray CT apparatus wherein the scan section for scanning the subject includes the radiation unit which applies radiation to the subject, and the detection unit which detects the radiation applied from the radiation unit and penetrated through the subject to obtain the raw data of each image, the present invention is not limited to it. For example, the present invention is applicable to a magnetic resonance imaging apparatus wherein a radiation unit applies electromagnetic waves to a subject lying within a static magnetic field, and a detection unit obtains each magnetic resonance signal outputted from the subject as raw data.

Although the above embodiment has explained, for instance, the example using X rays as the radiation applied by the radiation unit, the present invention is not limited to it. For example, radiation such as gamma rays may be used.

1. An elevating device comprising:
a reservoir which reserves fluid therein;
a pump comprising a suction port and a discharge port;
a cylinder configured to elevate an object to be elevated according to an amount of fluid held therein;
a first flow path which connects said reservoir and said suction port;
a second flow path which connects said discharge port and said cylinder;
a third flow path which connects said cylinder and said reservoir;
a fixed flow valve which is provided on said third flow path and causes fluid to flow at a predetermined flow rate; and
control device configured to control said pump, to lower the object to be elevated, so as to ad just a flow rate of discharge of the fluid by said pump to the same flow rate as the predetermined flow rate thereby to bring the discharge flow rate and a flow rate of the fluid returned to said reservoir through said fixed flow valve into equilibrium, and thereafter make the discharge flow rate smaller than the predetermined flow rate thereby to reduce the amount of the fluid held in said cylinder.

2. The elevating device according to claim 1, further comprising:
a first opening/closing valve provided on said second flow path;
a second opening/closing valve provided on said third flow path; and
a relief valve provided between said discharge port and said reservoir through a flow path interposed therebetween,
wherein said control device is configured to control said pump, said first opening/closing valve and said second opening/closing valve so as to adjust the discharge flow rate to the same flow rate as the predetermined flow rate in a state in which said first opening/closing valve and said second opening/closing valve are being closed therefore returns the fluid discharged from said pump to said reservoir via said relief valve, and thereafter open said first opening/closing valve and said second opening/closing valve simultaneously therefore to bring the discharge flow rate and the flow rate of the fluid returned to said reservoir into equilibrium.

3. The elevating device according to claim 2, wherein said relief valve is built in a pump unit comprising said pump and said reservoir.

4. The elevating device according to claim 2, wherein said control device is configured to control, to stop the lowering object to be elevated, so as to restore the discharge flow rate to the same flow rate as the predetermined flow rate and close said first opening/closing valve and said second opening/closing valve.

5. The elevating device according to claim 2, wherein said control device is configured to control, to lift the object to be elevated, so as to open said first opening/closing valve in a closed state of said second opening/closing valve thereby discharge the fluid from said pump to increase the amount of the fluid held in said cylinder.

6. The elevating device according to claim 2, further comprising a check valve configured to make the fluid flow direction to the direction extending from said first opening/closing valve to said cylinder, which is provided on said second flow path between said first opening/closing valve and said cylinder and sets.

7. The elevating device according to claim 1, further comprising a table moving section configured to move the object to be elevated into all imaging space, wherein the object to be elevated is a table section which supports a subject.

8. The elevating device according to claim 1, wherein said control device is configured to control the object to be elevated, based on at least one input information of a direction, an amount, a position and a velocity of the object to be elevated to be moved.

9. The elevating device according to claim 1, wherein said pump comprises a gear pump.

10. The elevating device according to claim 1, wherein the fluid is oil.

11. A method for controlling a elevating device for elevating all object to be elevated, the elevating device having a reservoir which reserves fluid therein, a pump having a suction port, and a discharge port, a cylinder which elevates an object to be elevated according to an amount of fluid held therein, a first flow path which connects the reservoir and the suction port of the pump, a second flow path which connects the discharge port of the pump and the cylinder, a third flow path which connects the cylinder and the reservoir, and a fixed flow valve which is provided on the third flow path and causes fluid to flow at a predetermined flow rate, said method comprising a step of:
controlling the pump, to lower the object to be elevated, so as to adjust a flow rate of discharge of the fluid by the pump to the same flow rate as the predetermined flow rate thereby to bring the discharge flow rate and a flow rate of the fluid returned to the reservoir through the fixed flow valve into equilibrium, and thereafter make the discharge flow rate smaller than the predetermined flow rate thereby to reduce the amount of the fluid held in the cylinder.

12. An imaging apparatus comprising:
a table section which supports a subject;
a table moving section configured to move said table section to an imaging space; and
an imaging device configured to image the subject supported by the table section, wherein said table moving section comprises:
a reservoir which reserves fluid therein,
a pump comprising a suction port and a discharge port,
a cylinder configured to elevate an object to be elevated according to an amount of fluid held therein,
a first flow path which connects said reservoir and said suction port,
a second flow path which connects said discharge port and said cylinder,
a third flow path which connects said cylinder and said reservoir,
a fixed flow valve which is provided on said third flow path and causes fluid to flow at a predetermined flow rate, and
control device configured to control said pump, to lower the object to be elevated, so as to adjust a flow rate of discharge of the fluid by said pump to the same flow rate as the predetermined now rate thereby to bring the discharge flow rate and a flow rate of the fluid returned to said reservoir through said fixed flow valve into equilibrium, and thereafter make the discharge flow rate smaller than the predetermined flow rate thereby to reduce the amount of the fluid held in said cylinder.

13. The imaging apparatus according to claim 12, wherein said table moving section further comprises:
a first opening/closing valve provided on said second flow path,
a second opening/closing valve provided on said third flow path, and
a relief valve provided between said discharge port and said reservoir through a flow path interposed therebetween,
wherein said control device comprises a first opening/closing valve provided on said second flow path;
a second opening/closing valve provided on said third flow path; and
a relief valve provided between said discharge port and said reservoir through a flow path interposed therebetween,
wherein said control device is configured to control said pump, said first opening/closing valve, and said second opening/closing valve so as to adjust the discharge flow rate to the same flow rate as the predetermined flow rate in a state in which said first opening/closing valve and said second opening/closing valve are being closed therefore returns the fluid discharged from said pump to said reservoir via said relief valve, and thereafter open said first opening/closing valve and said second opening/closing valve simultaneously therefore to bring the discharge flow rate and the flow rate of the fluid returned to said reservoir into equilibrium.

14. The imaging apparatus according to claim 13, wherein said relief valve is built in a pump unit said pump and said reservoir.

15. The imaging apparatus according to claim 13, wherein said control device is configured to control, to stop the lowering object to be elevated, so as to restore the discharge flow rate to the same flow rate as the predetermined flow rate and close said first opening/closing valve and said second opening/closing valve.

16. The imaging apparatus according to claim 13, wherein said control device is configured to control, to lift the object to be elevated, so as to open said first opening/closing valve in a closed state of said second opening/closing valve thereby discharge the fluid from said pump to increase the amount of the fluid held in said cylinder.

17. The imaging apparatus according to claim 13, wherein said table moving section further comprises a check valve for making the fluid flow direction to the direction extending from said first opening/closing valve to said cylinder, which is provided on said second flow path between said first opening/closing valve and said cylinder and sets.

18. The imaging apparatus according to claim 12, wherein said control device controls the object to be elevated, based on at least one input information of a direction, an amount, a position and a velocity of the object to be elevated to be moved.

19. The imaging apparatus according to claim 12, wherein said pump comprises a gear pump.

20. The imaging apparatus according to claim 12,
wherein said imaging device comprises a scan section configured to scan the subject moved into the imaging space, and
wherein said scan section includes comprises a radiation unit configured to apply radiation to the subject, and a detection unit configured to detect the radiation applied from said radiation unit and penetrated through the subject.
